(19) United States
(12) Patent Application Publication
(10) Pub. No.: US 2002/0056025 A1
(43) Pub. Date: May 9, 2002

(54) Systems and methods for management of memory

(76) Inventors: Chaoxin C. Qiu, Austin, TX (US); Mark J. Conrad, Colorado Springs, CO (US); Robert M. Farber, Austin, TX (US); Scott C. Johnson, Round Rock, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 09/797,198

(22) Filed: Mar. 1, 2001

Related U.S. Application Data
(60) Provisional application No. 60/246,445, filed on Nov. 7, 2000.
(60) Provisional application No. 60/246,359, filed on Nov. 7, 2000.

(51) Int. Cl. G06F 12/00

(52) U.S. Cl. 711/133; 709/201

(57) ABSTRACT

Memory management systems and methods that may be employed, for example, to provide efficient management of memory for network systems. The disclosed systems and methods may utilize a multi-layer queue management structure to manage buffer/cache memory in an integrated fashion. The disclosed systems and methods may be implemented as part of an information management system, such as a network processing system that is operable to process information communicated via a network environment, and that may include a network processor operable to process network-communicated information and a memory management system operable to reference the information based upon a connection status associated with the content.

This application claims priority from Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS” and to Provisional Application Serial No. 60/246,359 filed on Nov. 7, 2000 which is entitled “CACHING ALGORITHM FOR MULTIMEDIA SERVERS” the disclosures of each being incorporated herein by reference.

### BACKGROUND

The present invention relates generally to information management, and more particularly, to management of memory in network system environments.

In information system environments, files are typically stored by external large capacity storage devices, such as storage disks of a storage area network (“SAN”). Due to the large number of files typically stored on such devices, access to any particular file may be a relatively time consuming process. However, distribution of file requests often favors a small subset of the total files referenced by the system. In an attempt to improve speed and efficiency of responses to file requests, cache memory schemes, typically algorithms, have been developed to store some portion of the more heavily requested files in a memory form that is quickly accessible to a computer microprocessor, for example, random access memory (“RAM”). When cache memory is so provided, a microprocessor may access cache memory first to locate a requested file, before taking the processing time to retrieve the file from larger capacity external storage. In this manner, processing time may be conserved by reducing the amount of data that must be read from external and larger portions of memory. “Hit Ratio” and “Byte Hit Ratio” are two indices commonly employed to evaluate the performance of a caching algorithm. The hit ratio is a measure of how many of the file requests can be served from the cache and the byte hit ratio is a measure of how many bytes of total outgoing data flow can be served from the cache.

Most Internet web applications exhibit a large concentration in relatively small number of referenced files, in a manner as described above. Statistical analyses based on several web server traces have revealed that 10% of the files (i.e., “hot” files) accessed account for 90% of server requests and 90% of the bytes of information transferred (so-called the “10/90 rule” for web servers). This strong locality of “hot” file references has been used in a file system design to improve disk I/O performance as well as web cache memory design. However, the abovementioned “10/90 rule” does not necessarily translate into a cache memory hit ratio. For example, research has shown that caching hit ratio can be correlated to cache size via a log-like function. Thus, incremental improvement in hit ratio with increasing cache size may level off after a certain level of cache memory size is reached, meaning that further increases in cache memory size does not further improve the hit ratio. Although some research using lab simulations has reported hit ratios as high as 80%-90%, in practice few real-life traces have shown hit ratios higher than about 50%, and web cache hit ratios are often less than 40%.

Hard disk drives have considerably higher storage capacity and lower unit price than cache memory. Therefore cache memory size, e.g., for a traditional file server, should be carefully balanced between the cost of the memory and the incremental improvement to the cache hit ratio provided by additional memory. One generally accepted rule of thumb is that cache memory size should be at least 0.1 to 0.3% of storage size in order to see a tangible benefit. Most manufacturers today support a configurable cache memory size up to 1% of the storage size for traditional file system cache memory design.

Given the relative high cost associated with large amounts of cache memory, a number of solutions for offsetting this cost and maximizing utilization of cache memory have been proposed. For example, some present cache designs include deploying one or more computational algorithms for storing and updating cache memory. Many of these designs seek to implement a replacement policy that removes “cold” files and renews “hot” files. Specific examples of such cache designs include those employing simple computational algorithms such as random removal (RR) or first-in and first-out (FIFO) algorithms. Other caching algorithms consider one or more factors in the manipulation of content stored within the cache memory. Specific examples of algorithms that consider one reference characteristic include CLOCK-GCLOCK, partitioning, largest file first (SIZE), least-recently used (LRU), and least frequently used (LFU). Examples of algorithms that consider multiple factors include multi-level ordering algorithms such as LRUMIN, size-awared LRU, 2Q, SLRU, LRU-K, and Virtual Cache; key based ordering algorithms such as Log-2 and Hyper-G; and function based algorithms such as GreedyDual-size, GreedyDual, GD, LFU-DA, normalized cost LFU and GDSF.

However, as caching algorithms become more intelligent, the computational cost of the algorithms also generally increases. Function based or key-based caching algorithms typically involve some sorting and tracking of the access records and thus can push computational overhead to

O(log (N))˜O(N)

where N is the total number of objects (blocks) in the cache memory. At the same time, key-based algorithms may not provide better performance since a sorting function is typically used with the algorithm. Additionally, key-based algorithms require operational set up and assignments of keys for deploying the algorithm

### SUMMARY

Disclosed herein are systems and methods for memory management, such as web-based caching, and storage subsystem of a traditional file system that are relatively simple and easy to deploy and which offer reduced computational overhead for managing extremely large numbers of files relative to traditional memory management practices. Also disclosed are memory management algorithms that are effective, high performance and which have low operational cost so that they may be implemented in a variety of memory management environments, including high-end servers. Using the disclosed algorithms, buffer, cache and free pool memory may be managed together in an integrated fashion and used more effectively to improve system throughput.

Advantages of the disclosed systems and methods may be achieved by employing an integrated block/buffer logical management structure that includes at least two layers of a configurable number of multiple memory queues (e.g., at least one buffer layer and at least one cache layer). A two-dimensional positioning algorithm for memory units in the memory may be used to reflect the relative priorities of a memory unit in the memory in terms of parameters, such as parameters of both recency and frequency. For example, the algorithm may employ horizontal inter-queue positioning (i.e. the relative level of the current queue within a multiple memory queue hierarchy) to reflect memory unit popularity (e.g., reference frequency), and vertical intra-queue positioning (e.g., the relative level of a data block within each memory queue) to reflect (argumented) recency of a memory unit.

The disclosed integrated block/buffer management structure may be implemented to provide improved cache management efficiency with reduced computational requirements, including better cache performance in terms of hit ratio and byte hit ratio, especially in the case of small cache memory. This surprising performance is made possible, in part, by the use of natural movement of memory units in the chained memory queues to resolve the aging problem in a cache system. The unique integrated design of the management algorithms disclosed herein may be implemented to allow a block/buffer manager to track frequency of memory unit reference (e.g., one or more requests for access to a memory unit) consistently for memory units that are either in-use (i.e., in buffer state) or in-retain stage (i.e., in cache state) without additional computational overhead, e.g., without requiring individual parameter values (e.g., recency, frequency, etc.) to be separately calculated.

Using the disclosed integrated memory management structures, significant savings in computational resources may be realized by virtue of the fact that frequency of reference and aging are factored into a memory management algorithm via the chain depth of memory queues (“K”), thus avoiding tracking of reference count, explicit aging of reference count, and sorting of the reference order. Furthermore, memory unit movement in the logical management structure may be configured to involve simple identifier manipulation, such as manipulation of pointers, indices, etc. Thus, the disclosed integrated memory management structures may be advantageously implemented to allow control of cache management computational overhead in, for example, the O(1) scale, which will not increment along with the size of the managed cache/buffer memory.

In one particular embodiment, disclosed is a layered multiple LRU (LMLRU) algorithm that uses an integrated block/buffer management structure including two or more layers of a configurable number of multiple LRU queues and a two-dimensional positioning algorithm for data blocks in the memory to reflect the relative priority or cache value of a data block in the memory in terms of one or more parameters, such as in terms of both recency and frequency. A block management entity may be employed to continuously track the reference count when a memory unit is in the buffer layer state, and a timer (e.g., sitting barrier) may be implemented to further reduce the processing load required for caching management.

In one respect then, disclosed is a method of managing memory units using an integrated memory management structure, including: assigning memory units to one or more positions within a buffer memory defined by the integrated structure; subsequently reassigning the memory units from the buffer memory to one or more positions within a cache memory defined by the integrated structure; and subsequently removing the memory units from assignment to a position within the cache memory; and in which the assignment, reassignment and removal of the memory units is based on one or more memory state parameters associated with the memory units.

In another respect, disclosed is a method of managing memory units using an integrated two-dimensional logical memory management structure, including: providing a first horizontal buffer memory layer including two or more sequentially ascending buffer memory positions; providing a first horizontal cache memory layer including two or more sequentially ascending cache memory positions, the first horizontal cache memory layer being vertically offset from the first horizontal buffer memory layer; horizontally assigning and reassigning memory units between the buffer memory positions within the first horizontal buffer memory layer based on at least one first memory state parameter; horizontally assigning and reassigning memory units between the cache memory positions within the first horizontal cache memory layer based on at least one second memory state parameter; and vertically assigning and reassigning memory units between the first horizontal buffer memory layer and the first horizontal cache memory layer based on at least one third memory state parameter.

In another respect, disclosed is a method of managing memory units using a multi-dimensional logical memory management structure that may include two or more spatially-offset organizational sub-structures, such as two or more spatially-offset rows, columns, layers, queues, combinations thereof, etc. Each spatially-offset organizational sub-structure may include one position, or may alternatively be subdivided into two or more positions within the substructure that may be further organized within the substructure, for example, in a sequentially ascending manner, sequentially descending manner, or using any other desired ordering manner. Such organizational sub-structures may be spatially offset in symmetric or asymmetric spatial relationship, and in a manner that forms, for example, a two-dimensional or three-dimensional management structure. In one possible implementation of the disclosed multi-dimensional memory management structures, memory units may be assigned or reassigned in any suitable manner between positions located in different organizational sub-structures, between positions located within the same organizational sub-structure, combinations thereof, etc. Using the disclosed multi-dimensional memory management logical structures advantageously allows the changing value or status of a given memory unit in terms of multiple memory state parameters, and relative to other memory units within a given structure, to be tracked or otherwise followed or maintained with greatly reduced computational requirements, e.g., in terms of calculation, sorting, recording, etc.

For example, in one exemplary application of a multi-dimensional memory management structure as described above, reassignment of a memory unit from a first position to a second position within the structure may be based on relative positioning of the first position within the structure and on two or more parameters, and the relative positioning of the second position within the structure may reflect a renewed or updated combined cache value of the memory unit relative to other memory units in the structure in terms of the two or more parameters. Advantageously, vertical and horizontal assignments and reassignments of a memory unit within a two-dimensional structure embodiment of the algorithm may be employed to provide continuous mapping of a relative positioning of the memory unit that reflects a continuously updated combined cache value of the memory unit relative to other memory units in the structure in terms of the two or more parameters without requiring individual values of the two or more parameters to be explicitly recorded and recalculated. Such vertical and horizontal assignments also may be implemented to provide removal of memory units having the least combined cache value relative to other memory units in the structure in terms of the two or more parameters, without requiring individual values of the two or more parameters to be explicitly recalculated and resorted.

In another respect, disclosed is an integrated two-dimensional logical memory management structure, including: at least one horizontal buffer memory layer including two or more sequentially ascending buffer memory positions; and at least one horizontal cache memory layer including one or more sequentially ascending cache memory positions and a lowermost memory position that includes a free pool memory position, the first horizontal cache memory layer being vertically offset from the first horizontal buffer memory layer.

In another respect, disclosed is a method of managing memory units, including: assigning a memory unit to one of two or more memory positions based on a status of at least one memory state parameter; and in which the two or more memory positions include at least two positions within a buffer memory, the at least one memory state parameter includes an active connection count (ACC).

In another respect, disclosed is a method for managing content in a network environment comprising: determining the number of active connections associated with content used within the network environment; and referencing the content location based on the determined connections.

In another respect, disclosed is a network processing system operable to process information communicated via a network environment. The system may include a network processor operable to process network-communicated information and a memory management system operable to reference the information based upon one or more parameters, such as a connection status associated with the information.

### BRIEF DESCRIPTION OF THE DRAWINGS

FIG. 1 illustrates a memory management structure according to one embodiment of the disclosed methods and systems.

FIG. 2 illustrates a memory management structure according to another embodiment of the disclosed methods and systems.

FIG. 3 illustrates a state transition table for a memory management structure according to one embodiment of the disclosed methods and systems.

FIG. 4 illustrates the management of memory by a memory management structure according to one embodiment of the disclosed methods and systems.

FIG. 5 illustrates the management of memory by a memory management structure according to one embodiment of the disclosed methods and systems.

FIG. 6 illustrates the management of memory by a memory management structure according to one embodiment of the disclosed methods and systems.

FIG. 7 illustrates the management of memory by a memory management structure according to one embodiment of the disclosed methods and systems.

### DESCRIPTION OF ILLUSTRATIVE EMBODIMENTS

Disclosed herein are two dimensional methods and systems for managing memory that employ multiple-position layers (e.g., layers of multiple queues, multiple cells, etc.) and that may b e advantageously implemented with a variety of types of information management systems, including network content delivery systems. By using a two-dimensional approach, particular memory units may be characterized, tracked and managed based on multiple parameters associated with each memory unit. Using multiple and interactive layers of configurable queues allows memory units to be efficiently assigned/reassigned between queues of different memory layers, e.g., between a buffer layer and a cache layer, based on multiple parameters. Any type of memory may be managed using the methods and systems disclosed herein, including memory associated with continuous information (e.g., streaming audio, streaming video, RTSP, etc.) and non-continuous information (e.g., web pages, HTTP, FTP, Email, database information, etc.). However, in one embodiment, the disclosed systems and methods may be advantageously employed to manage memory associated with non-continuous information.

The disclosed methods and systems may be implemented to manage memory units stored in any type of memory storage device or group of such devices suitable for providing storage and access to such memory units by, for example, a network, one or more processing engines or modules, storage and I/O subsystems in a file server, etc. Examples of suitable memory storage devices include, but are not limited to (“RAM”), disk storage, I/O subsystem, file system, operation system, or combinations thereof. Similarly, memory units may be organized and referenced within a given memory storage device or group of such devices using any method suitable for organizing and managing memory units. For example, a memory identifier, such as a pointer or index, may be associated with a memory unit and “mapped” to the particular physical memory location in the storage device (e.g. first node of Q₁^{used}=location FF00 in physical memory). In such an embodiment, a memory identifier of a particular memory unit may be assigned/reassigned within and between various layer and queue locations without actually changing the physical location of the memory unit in the storage media or device. Further, memory units, or portions thereof, may be located in non-contiguous areas of the storage memory. However, it will be understood that in other embodiments memory management techniques that use contiguous areas of storage memory and/or that employ physical movement of memory units between locations in a storage device or group of such devices may also be employed. Further, status of a memory parameter/s may be expressed using any suitable value that relates directly or indirectly to the condition or value of a given memory parameter.

Examples of memory parameters that may be considered in the practice of the disclosed methods and systems include any parameter that at least partially characterizes one or more aspects of a particular memory unit including, but not limited to, parameters such as recency, frequency, aging time, sitting time, size, fetch (cost), operator-assigned priority keys, status of active connections or requests for a memory unit, etc. With regard to these parameters, recency (e.g. of a file reference) relates to locality in terms of current trend of memory unit reference and includes, for example, least-recently-used (“LRU”) cache replacement policies. Frequency (e.g. of a file reference) relates to locality in terms of historical trend of memory unit reference, and may be employed to compliment measurements of recency. Aging is a measurement of time passage since a memory unit was last referenced, and relates to how “hot” or “cold” a particular memory unit currently is. Sitting time (“ST”) is a measurement of how long a particular memory unit has been in place at a particular location within a caching/buffering structure, and may be controlled to regulate frequency of memory unit movement within a buffer/caching queue. Size of memory unit is a measurement of the amount of buffer/cache memory that is consumed to maintain a given referenced memory unit in the buffer or cache, and affects the capacity for storing other memory units, including smaller frequently referenced memory units.

The disclosed methods and systems may utilize individual memory positions, such as memory queues or other memory organizational units, that may be internally organized based on one or more memory parameters such as those listed above. In the case of memory queues, examples of suitable intra-queue organization schemes include, but are not limited to, least recently used (“LRU”), most recently used (“MRU”), least frequently used (“LFU”) FIFO, etc. Memory queues may be further organized in relation to each other using two or more layers of queues based on one or more other parameters, such as status of requests for access to a memory unit, priority class of request for access to a memory unit (e.g., based on Quality of Service (“QoS”) parameters, Service Level Agreement (“SLA”) parameter), etc. Within each queue layer, multiple queues may be provided and organized in an intra-layer hierarchy based on additional parameters, such as frequency of access, etc. Dynamic reassignment of a given memory unit within and between queues, as well as between layers, may be effected based on parameter values associated with the given memory unit, and/or based on the relative values of such parameters in comparison with other memory units.

The provision of multiple queues, and layers of multiple queues, provides a two-dimensional logical memory management structure capable of assigning and reassigning memory in consideration of multiple parameters, increasing efficiency of the memory management process. The capability of tracking and considering multiple parameters on a two-dimensional basis also makes possible the integrated management of individual types of memory (e.g., buffer memory, cache memory and/or free pool memory), that are normally managed separately.

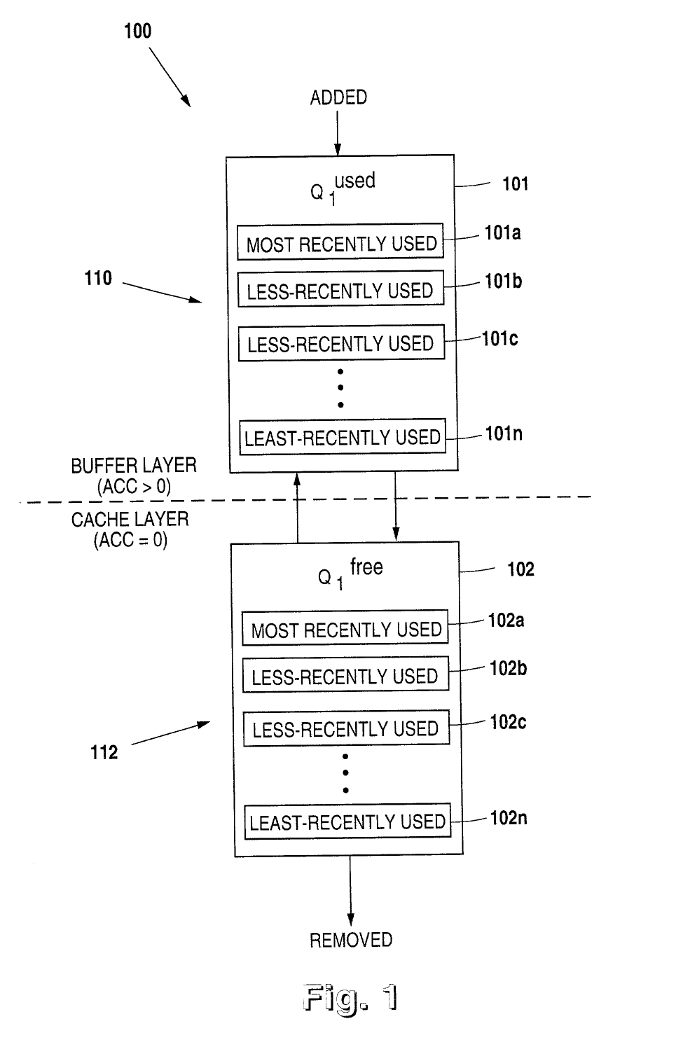

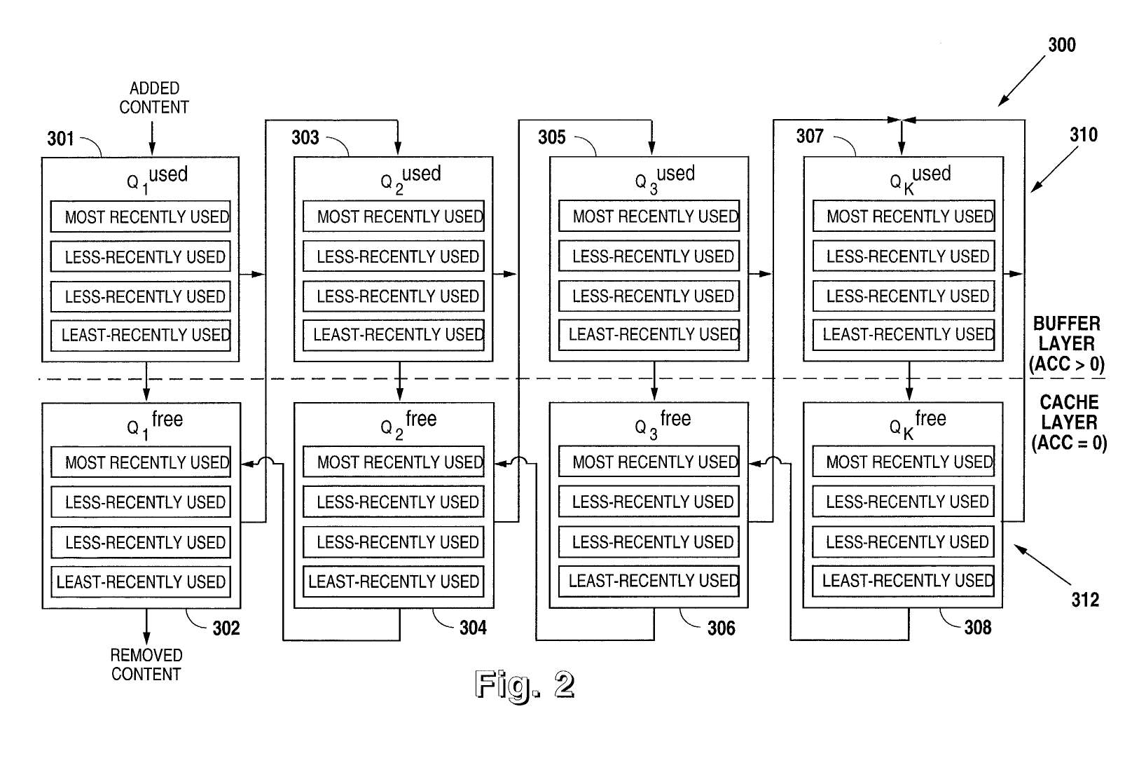

FIGS. 1 and 2 illustrate exemplary embodiments of respective logical structures 100 and 300 that may be employed to manage memory units within a memory device or group of such devices, for example, using an algorithm and based on one or more parameters as described elsewhere herein. As such, logical structures 100 and 300 should not be viewed to define a physical structure of a memory device or memory locations, but as a logical methodology for managing content or information stored within a memory device or a group of memory devices. Further, although described herein in relation to block level memory, it will be understood that embodiments of the disclosed methods and system may be implemented to manage memory units on virtually any memory level scale including, but not limited to, file level units, bytes, bits, sector, segment of a file, etc. However, management of memory on a block level basis instead of a file level basis may present advantages for particular memory management applications, by reducing the computational complexity that may be incurred when manipulating relatively large files and files of varying size. In addition, block level management may facilitate a more uniform approach to the simultaneous management of files of differing type such as HTTP/FTP and video streaming files.

FIG. 1 illustrates a management logical structure 100 for managing memory that employs two horizontal queue layers 110 and 112, between which memory may be vertically reassigned. Each of layers 110 and 112 are provided with respective memory queues 101 and 102. It will be understood that FIG. 1 is a simplified representation that includes only one queue per layer for purpose of illustrating vertical reassignment of memory units between layers 110 and 112 according to one parameter (e.g., status of request for access to the memory unit), and vertical ordering of memory units within queues 101 and 102 according to another parameter (e.g., recency of last request). However, as described further herein two or more multiple queues may be provided for each given layer to enable horizontal reassignment of memory units between queues based on an additional parameter (e.g., frequency of requests for access). One example of an embodiment in which memory units may be both vertically and horizontally reassigned will be discussed later in reference to FIG. 2.

In the embodiment illustrated in FIG. 1, first layer 110 is a buffer management structure that has one buffer queue 101 (i.e., Q₁^{used}) representing used memory, or memory currently being accessed by at least one active connection. Second layer 112 is a cache management structure that has one cache queue 102 (i.e., cache layer Q₁^{free}) representing cache memory, or memory that was previously accessed, but is now free and no longer associated with an active connection. As indicated by the arrows, a memory unit (e.g., memory block) may be added to layer 110 (e.g., at the top of Q₁^{used}), vertically reassigned between the layers 110 and 112 (e.g., between Q₁^{used} and Q₁^{free}) in either direction, and may be removed from layer 112, (e.g., at the bottom of Q₁^{free}). For illustration purposes, an exemplary embodiment employing memory blocks will be further discussed in relation to the figures, although as mentioned above it will be understood that other types of memory units may be employed.

As illustrated in FIG. 1, each of queues 101 and 102 are LRU queues. In this regard, Q₁^{used} buffer queue 101 includes a plurality of nodes 101a, 101b, 101c, . . . 101n that may represent, for example, units of content stored in memory in an LRU organization scheme (e.g., memory blocks, pages, etc.). For example, Q₁^{used} buffer queue 101 may include a most-recently used 101a unit, a less-recently used 101b unit, a less-recently used 101 c unit, and a least-recently used 101n unit that all represent a memory unit that is currently associated with one or more active connections. In a similar manner, Q₁^{free} cache queue 102 includes a plurality of memory blocks which may include a most-recently used 102a unit, a less-recently used 102b unit, a less-recently used 102c unit, and a least-recently used 102n unit. Although LRU queues are illustrated in FIG. 1, it will be understood that other types of queue organization may be employed, for example, MRU, LFU, FIFO, etc.

Although not illustrated, it will be understood that individual queues, e.g. such as Q₁^{used} memory 101 and Q₁^{free} memory 102, may include additional or fewer memory blocks, i.e., n represents the total number of memory blocks in a queue, and may be any number greater than or equal to one based on the particular needs of a given memory management application environment. In addition, the total number of memory blocks (n) employed per queue need not be the same, and may vary from queue to queue as desired to fit the needs of a given application environment.

Using memory management logical structure 100, memory blocks may be managed (e.g. assigned, reassigned, copied, replaced, referenced, accessed, maintained, stored, etc.) within memory queues Q₁^{used} 101 and Q₁^{free} 102, and between buffer memory layer 110 and free memory layer 112 using an algorithm that considers one or more of the parameters previously described. For example, relative vertical position of individual memory blocks within each memory queue may be based on recency, using an LRU organization as follows. A memory block may originate in an external high capacity storage device, such as a hard drive. Upon a request for access to the memory block by a network or processing module, it may be copied from the external storage device and added to the Q₁^{used} memory queue 101 as most recently used memory block 101a, vertically supplanting the previously most-used memory block which now takes on the status of less-recently used memory block 101b as shown. Each successive memory block within used memory queue 101 is vertically supplanted in the same manner by the next more recently used memory block. It will be understood that a request for access to a given memory block may include a request for a larger memory unit (e.g., file) that includes the given memory block.

When all requests for access to a memory block are completed or closed, so that a memory block is no longer the subject of an active request, the memory block may be vertically reassigned from buffer memory layer 110 to free cache memory layer 112. This is accomplished by reassigning the memory block from the Q₁^{used} memory queue 101 to the top of Q₁^{free} memory queue 102 as most recently used memory block 102a, vertically supplanting the previously most-used memory block which now takes on the status of less-recently used memory block 102b as shown. Each successive memory block within Q₁^{free} memory queue 102 is vertically supplanted in the same manner by the next more recently used memory block, and the least recently used memory block 102n is vertically supplanted and removed from the bottom of the Q₁^{free} memory queue 102.

With regard to block replacement, Q₁^{free} memory queue 102 may be fixed, so that removal of block 102n automatically occurs when Q₁^{free} memory queue 102 is full and a new block 102a is reassigned from Q₁used memory queue 101 to Q₁^{free} memory queue 102.

Alternatively, Q₁^{free} memory queue 102 may be flexible in size and the removal of block 102n may occur only when the buffer/cache memory is full and additional memory space is required in buffer/cache storage to make room for the assignment of a new block 101a to the top of Q₁^{used} memory queue 101 from external storage. It will be understood that these represent just two possible replacement policies that may be implemented and that other alternate replacement policies are also possible to accomplish removal of memory blocks from Q₁^{free} memory queue 102.

In the illustrated embodiment, memory blocks may be vertically managed (e.g. assigned and reassigned between cache layer 112 and buffer layer 110 in the manner described above) using any algorithm or other method suitable for logically tracking the connection status (i.e., whether or not a memory blocks is currently being accessed). For example, a variable or parameter may be associated with a given block to identify the number of active network locations requesting access to the memory block, or to a larger memory unit that includes the memory block. Using such a parameter, memory blocks may be vertically managed based upon the number of open or current requests for a given block, with blocks currently accessed being assigned to buffer layer 110, and then reassigned to cache layer 112 when access is discontinued 25 or closed.

To illustrate, in one embodiment an integer parameter (“ACC”) representing the active connection count may be associated with each memory block maintained in the memory layers of logical structure 100. The value of ACC may be set to reflect the total number of access 30 connections currently open and transmitting, or otherwise actively using or requesting the contents of the memory block. Memory blocks may be managed by an algorithm using the 14 SURG-125 changing ACC values of the individual blocks. For example, when an unused block in external storage is requested or otherwise accessed by a single connection, the ACC value of the block may be set at one and the block assigned or added to the top of Q₁^{used} memory 101 as most recently used block 101a. As each additional request for access is made for the memory block, the ACC value may be incremented by one for each additional request. As each request for access for the memory block is discontinued or closed, the ACC value may be decremented by one.

As long as the ACC value associated with a given block remains greater than or equal to one, it remains assigned to Q₁^{used} memory queue 101 within buffer management structure layer 110, and is organized within queue 101 using the LRU organizational scheme previously described. When the ACC value associated with a given block decreases to zero (all requests or access cease), the memory block may be reassigned to Q₁ ^{free} memory queue 102 within cache management structure layer 112, where it is organized following the LRU organizational scheme previously described. If a new request for access to the memory block is made, the value of ACC is incremented from zero to one and it is reassigned to Q₁ ^{used} memory queue 101. If no new request for access is made for the memory block it remains in Q₁^{free} memory queue 102 until it is removed from the queue in a manner as previously described.

FIG. 2 illustrates another possible memory management logical structure embodiment 300 that includes two layers 310 and 312 of queues linked together with multiple queues in each layer. The variable K represents the total number of queues present in each layer and is a configurable parameter, for example, based on the cache size, “turnover” rate (how quick the content will become “cold”), the request hit intensity, the content concentration level, etc. In the case of FIG. 2, K has the value of four, although any other total number of queues (K) may be present including fewer or greater numbers than four. In one exemplary embodiment, the value of K is less than or equal to 10.

The memory management logical structure 300 illustrated in FIG. 2 employs two horizontal queue layers 310 and 312, between which memory may be vertically reassigned. Buffer layer 310 is provided with buffer memory queues 301, 303, 305 and 307. Cache layer 310 is provided with cache memory queues 302, 304, 306 and 308.

The queues in buffer layer 310 are labeled as Q₁^{used}, Q₂^{used}, Q_{K}^{used}, and the queues in cache layer 312 are labeled as Q₁^{free}, Q₂^{free}, . . . Q_{K}^{free}. The queues in buffer layer 310 and cache layer 312 are each shown organized in sequentially ascending order using sequentially ordered identification values expressed as subscripts 1, 2, 3, . . . K, and that are ordered in this example, sequentially from lowermost to highermost value, with lowermost values closest to memory unit removal as will be further described herein. It will be understood that a sequential identification value may be any value (e.g., number, range of numbers, integer, other identifier or index, etc.) that may be associated with a queue or other memory position that serves to define relative position of a queue within a layer and that may be correlated to one or more memory parameters, for example, in a manner so as to facilitate assignment of memory units based thereon. Like FIG. 1, each of the queues of FIG. 2 are shown as LRU organized queues, with the “most-recently-used” memory block on the top of the queue and the “least recently-used” memory on the bottom.

In the embodiment of FIG. 2, the entire memory space used by buffering and cache layers 310 and 312 of memory management structure 300 is logically partitioned into three parts: buffer space, cache space, and free pool. In this regard, cache layer queue Q₁^{free} is the free pool to which is assigned blocks having the lowest caching priority. The remaining layer 312 queues (Qᵢ^{free}, i>1) may be characterized as the cache, and the layer 310 queues (Qᵢ^{used}) characterized as the buffer.

As illustrated by FIG. 2, the provision of multiple queues within each of multiple layers 310 and 312 enables both “vertical” and “horizontal” assignment and reassignment of memory within structure 300, for example, as indicated by the arrows between the individual queues of FIG. 2. As previously described in relation to FIG. 1, “vertical” reassignment between the two layers 310 and 312 may be managed by an algorithm in combination with a parameter such as an ACC value that tracks whether or not there exists an active connection (i.e., request for access) to the block. Thus, when an open connection is closed, the ACC value of each of its associated blocks will decrement by one.

Vertical block reassignment within the logical structure of FIG. 2 may occur as follows. A given memory block may have a current ACC value greater than one and be currently assigned to a particular memory queue in buffer layer 310, denoted here as Qᵢ^{used} where the queue identifier i represents the number of the queue within layer 310 (e.g., 1, 2, 3, . . . K). Upon decremation of its ACC value to zero, the block will be vertically reassigned to the top of Qᵢ^{free}, vertically re-locating the block from buffer layer 210 to cache layer 312. However, if the ACC value of the same given block is greater than zero after decremation of the ACC value the block will not be reassigned from layer 310 to layer 312. Thus, the layer of the queue (i.e., buffer or cache) to which a given memory block is vertically assigned reflects whether or not an active request for access to the block currently exists, and the relative vertical assignment of the memory block in a given buffer or cache queue reflects the recency of the last request for access to the given block.

Horizontal block assignment and reassignment within the logical structure of FIG. 2 may occur as follows. When a given block is fetched from an external storage device due to a request for access, the block is initially assigned to the top of the Q₁^{used} queue 301 as the most recently used block, with its ACC value set to one. With each additional concurrent request for access to the block, the ACC value is incremented by one and horizontally reassigned to the top of the next buffer queue, Qᵢ₊₁ used. If additional concurrent requests for access to the given memory block are received, the ACC value is incremented again and the block is horizontally reassigned to the next higher buffer queue. Horizontal reassignment of the block continues with increasing ACC value until the block reaches the last queue, Q_{K}^{used} where the block will remain as long as its ACC value is greater than or equal to one. Thus, the buffer queue to which a given memory block is horizontally assigned reflects the historical frequency and number of concurrent requests received for access to the given block.

When the ACC value of a given memory block drops to zero (e.g., no active requests for the memory block remain open), the memory block is vertically reassigned from buffer layer 310 to cache layer 312, in a manner similar to that described in relation to FIG. 1. However, as depicted by the arrows in the logical structure 300 of FIG. 2, the particular cache layer queue Qᵢ^{free} to which the memory block is vertically reassigned is dictated by the particular buffer layer queue Qᵢ^{used} from which the memory block is being reassigned, i.e., the buffer queue to which the memory block was assigned prior to closing of the last remaining open request for access to that block. For example, a memory block assigned to buffer layer queue Q₃ used will be reassigned to cache layer queue Q₃ ^{free} upon closure of the last open request for access to that memory block.

Once assigned to a queue Qᵢ^{free} in cache layer 312, a memory block will remain assigned to the cache layer until it is the subject of another request for access. As long as no new request for access to the block is received, the block will be horizontally reassigned downwards among the cache layer queues as follows. Within each cache layer queue, memory blocks may be vertically managed employing an LRU organization scheme as previously described in relation to FIG. 1. With the exception of the free pool queue (Q₁^{free}), each cache layer queue (Qᵢ^{free}, i>1) may be fixed in size so that each memory block that is added to the top of a non-free pool cache layer queue as the most recently used memory block serves to displace and cause reassignment of the least recently used memory block from the bottom of the non-free pool cache layer queue to the top of the next lower cache layer queue Qᵢ₋₁^{free}, for example, in a manner as indicated by the arrows in FIG. 2. This vertical reassignment will continue as long as no new request for access to the block is received, and until the block is reassigned to the last cache layer queue (Q₁^{free}), the free pool.

Thus, by fixing the depth of non-free pool cache layer queues Q_{K}^{free} . . . , Q₃^{free} and Q₂^{free}, memory blocks having older reference records (i.e., last request for access) will be gradually moved down to the bottom of each non-free pool cache queue (Qᵢ^{free}, i>1) and be reassigned to the next lower cache queue Qᵢ₋₁^{free} if the current non-free pool cache queue is full. By horizontally reassigning a block in the bottom of each non-free pool cache queue (Qᵢ^{free}, i>1) to the top of the next lower cache queue Qᵢ₋₁^{free}, reference records that are older than the latest reference (i−1) may be effectively aged out. However, if a memory block within Qⱼ^{free} is referenced (i.e., is the subject of a new request for access) prior to being aged out, then it will be reassigned to a buffer layer queue Qᵢ₊1used as indicated by the arrows in FIG. 2, with its ACC value set to 1. This reassignment ensures that a block in active use is kept in the buffer layer 310 of logical structure 300.

It is possible that the buffer layer queues and/or the last cache layer queue Q₁^{free} may be fixed in size like non-free pool cache layer queues (Qᵢ^{free}, i>1). However, it may be advantageous to provision all buffer layer queues Q_{K}^{used} . . . , Q₃^{used}, Q₂^{used} and Q₁^{used} to have a flexible size, and to provision last cache layer queue Q₁^{free} as a flexible-sized memory free pool. In doing so, the amount of memory available to the buffer layer queues may be maximized and memory blocks in the buffer layer will never be removed from memory. This is so because each of the buffer layer queues may expand as needed at the expense of memory assigned to the free pool Q₁^{free}, and the only possibility for a memory block in Q₁^{used} to be removed is when all active connections are closed. In other words, the size of memory free pool Q₁^{free} may be expressed at any given time as the total available memory less the fixed amount of memory occupied by blocks assigned to the cache layer queues less the flexible amount of memory occupied by blocks assigned to the buffer layer queues, i.e., free pool memory queue Q₁^{free} will use up all remaining memory space.

In one possible implementation, an optional queue head depth may be used in managing the memory allocation for the flexible sized queues of a memory structure. In this regard, a queue head depth counter may be used to track the availability of the slots in the particular flexible queue. When a new block is to be assigned to the queue, the queue head depth counter is checked to determine whether or not a new block assignment may be simply inserted into the queue, or whether a new block assignment or group of block assignments are first required to be made available. Other flexible queue depth management schemes may also be employed.

In the embodiment of FIG. 2 when a new memory block is required from storage (e.g., a miss), an existing older memory block assignment is directly removed from the bottom of free pool queue Q₁^{free} and replaced with an assignment of the new requested block to buffer layer queue Q₁^{used}. When a system is overloaded or very busy, it may be possible that all blocks in Q₁^{free} are used up. In this case, new I/O requests may be queued up to wait until some blocks are pushed into Q₁^{free} from either Q₁^{used} or Q₂free in a manner as previously described, rather than moving memory blocks from other queues into Q₁^{free} to make room for new I/O requests, as the latter may only tend to further saturate the system performance. In such a case, the resource manager may instead be informed of the unavailability of memory management resources, so that new client requests may be put on hold, transferred to another system, or rejected.

As is the case with other embodiments described herein, storage and logical manipulation of memory assignments described in relation to FIG. 2 may be accomplished by any processor or group of processors suitable for performing these tasks. Examples include a buffer/cache manager (e.g., storage management processing engine or module, resource manager, file processor, etc.) of an information management system, such as a content delivery system. Likewise resource management functions may be accomplished by a system management engine or host processor module of such a system. A specific example of such a system is a network processing system that is operable to process information communicated via a network environment, and that may include a network processor operable to process network-communicated information and a memory management system operable to reference the information based upon a connection status associated with the content.

Examples of a few of the types of system configurations with which the disclosed methods and systems may be advantageously employed are described in concurrently filed, co-pending U.S. patent application Ser. No. ______, entitled “Network Connected Computing System”, by Scott C. Johnson et al.; and in concurrently filed, co-pending U.S. patent application Ser. No. ______, entitled “System and Method for the Deterministic Delivery of Data and Services,” by Scott C. Johnson et al., each of which is incorporated herein by reference. Other examples of memory management methods and systems that may be employed in combination with the method and systems described herein may be found in concurrently filed, co-pending U.S. patent application Ser. No. ______, entitled “Systems and Methods for Management of Memory in Information Delivery Environments”, by Chaoxin C. Qiu, et al., which is incorporated herein by reference.

In one embodiment, optional additional parameters may be considered by a caching algorithm to minimize unnecessary processing time that may be consumed when a large number of simultaneous requests are received for a particular memory unit (e.g., particular file or other unit of content). The intensity of reassignment within the logical memory structure that may be generated by such requests for “hot” content has the potential to load-up or overwhelm an internal processor, even when memory units are managed and reassigned only by reference with identifier manipulations. Examples of parameters that may be employed to “slow down” or otherwise attenuate the frequency of reassignment of memory blocks in response to requests for such hot content include, but are not limited to, sitting time of a memory block, processor-assigned flags associated with a memory block, etc.

One or more configurable parameters of the disclosed memory management structures may be employed to optimize and/or prioritize the management of memory. Examples of such configurable aspects include, but are not limited to, cache size, number of queues in each layer (e.g., based on cache size and/or file set size), a block reassignment barrier that may be used to impact how frequently a memory system manager needs to re-locate a memory block within the buffer/cache, a file size threshold that may be used to limit the size of files to be cached, etc. Such parameters may be configurable dynamically by one or more system processors (e.g., automatically or in a deterministic manner), may be pre-configured or otherwise defined by using a system manager such as a system management processing engine, or configured using any other suitable method for real-time configuration or pre-configuration.

A block reassignment barrier may be advantageously employed to control or resist high frequency movement in the caching queue that may occur in a busy server environment, where “hot” contents can be extremely “hot” for a short period of time. Such high frequency movement may consume large amounts of processing power. A file size threshold may be particularly helpful for applications such as HTTP serving where traffic analysis suggests that extremely large files in a typical Web server may exist with a low referencing frequency level. When these files are referenced and assigned to cache, a large chunk of blocks in the cache memory are occupied, reducing the caching capacity for smaller but frequently referenced files.

For example, in one exemplary embodiment a specified resistance barrier timer (“RBT”) parameter may be compared to a sitting time (“ST”) parameter of a memory block within a given queue location to minimize unnecessary assignments and reassignments within the memory management logical structure. In such an embodiment, an RBT may be specified in units of seconds, and each memory block in the cache layer 312 may be provisioned with a variable ST time parameter that is set to the time when the block is assigned or reassigned to the current location (i.e., queue) of the caching/buffering structure. Thus, the ST is reset each time the block is reassigned. The ST may then be used to calculate how long a block has been assigned to a particular location, and this value may be compared to the RBT to limit reassignment of the block as so desired. One example of how the ST and RBT may be so employed is described below, although it will be understood that other methodologies may be used. Further, as with other memory parameters described herein, RBT and ST may be expressed using any value, dimensional or dimensionless, that represents or is related to the desired times associated therewith.

In one embodiment, downward vertical reassignments between buffer layer 310 and cache layer 312 are not affected by the ST value, but are allowed to occur as ACC value is decremented in a manner as previously described. This may be true even though the ST value will be re-set to the time of downward reassignment between the layers. However, horizontal reassignments between buffer layer queues are limited by the ST value if this value does not exceed the specified RBT. This serves to limit the rate at which a block may be horizontally reassigned from lower to higher queues within the buffer layer 310, e.g., when a high frequency of requests for access to that block are encountered. To illustrate this policy, if a given memory block is assigned to a particular buffer layer queue Qᵢ^{used} and is referenced by a request for access, then its ACC is incremented by one, and the time elapsed between the current time and the marked time in the ST parameter is compared with the RBT. If the time elapsed is less than the RBT, the block remains in the same buffer layer queue Qᵢ^{used}. However, if this elapsed time is greater than or equal to the RBT, then the block is horizontally reassigned to Qᵢ₊₁ used, in a manner as previously described.

Summarizing the above-described embodiment, if a given memory block belongs to Qᵢ^{used}, then the only possibilities for reassignment of the block are: 1) to be moved to Qᵢ^{free} if all active connections are closed; 2) to be moved to Qᵢ₊₁ used if the sitting period is satisfied and more references occur; or 3) to stay in the same Qᵢ^{used} if the sitting period is not satisfied. Thus, in this embodiment the index i may be characterized as reflecting a “normalized” frequency count.

It will be understood that the value of RBT may be a common pre-defined value for all memory blocks, a pre-defined value that varies from memory block to memory block, or may be a dynamically assigned common value or value that varies from memory block to memory block. For example, in one embodiment the total file set in storage may be partitioned into various resistance zones where each zone is assigned a separate RBT. In implementation, such a partitioned zone may be, for example, a subdirectory having an RBT that may be assigned, for example, based on an analysis of the server log history. Such an implementation may be advantageously employed, for example, in content hosting service environments where a provider may host multiple Web server sites having radically different workload characteristics.

In another exemplary embodiment, one or more optional flags may be associated with one or more memory blocks in the cache/buffering memory to influence the behavior of the memory management algorithm with respect to given blocks. These flags may be turned on if certain properties of a file are satisfied. For example, a file processor may decide whether or not a flag should be turned on before a set of blocks are reserved for a particular file from external storage. In this way one or more general policies of the memory management algorithm described above may be overwritten with other selected policies if a given flag is turned on.

In the practice of the disclosed methods and systems, any type of flag desirable to affect policies of a memory management system may be employed. One example of such a flag is a NO_CACHE flag, and it may be implemented in the following manner. If a memory block assigned to the buffer layer 310 has its associated NO_CACHE flag turned on, then the block will be reassigned to the top of the free pool Q₁^{free} when all of its associated connections or requests for access are closed (i.e. when its ACC value equals zero). Thus, when so implemented, blocks with having a NO_CACHE flag turned on are not retained in the cache queues of layer 312 (i.e., Q₂^{free}, Q₃^{free}, and Q_{K}^{free}).

In one exemplary embodiment, a NO_CACHE flag may be controlled by a file processor based on a configurable file size threshold (“FILE_SIZE_TH”). When the file processor determines that a requested file is not in the memory and needs to be fetched from external storage (e.g., disk), the file processor may compare the size of the newly requested file to the threshold FILE_SIZE_TH. If the size of the newly requested file is less than FILE_SIZE_TH, all blocks associated with the file shall have their associated NO_CACHE flags turned off (default value of the flag). If the size of the newly requested file is greater than or equal to the threshold FILE_SIZE_TH, then all memory blocks associated with the file shall have their associated NO_CACHE flags turned on. When so implemented, memory blocks associated with files having sizes greater than FILE_SIZE_TH are not retained in the cache queues of layer 312. It will be understood that other types of flags, and combinations of multiple flags are also possible, including flags that may be used to associate a priority class with a given memory unit (e.g., based on Quality of Service (“QoS”) parameters, Service Level Agreement (“SLA”) parameter), etc. For example, such a flag may be used to “push” the assignment of a given memory to a higher priority queue, higher priority memory layer, vice-versa, etc.

Although two layers of memory queues are illustrated for the exemplary embodiments of FIGS. 1 and 2, it will be understood that more than two layers may be employed, if so desired. For example, two buffer layers e.g., a primary buffer layer and a secondary buffer layer, may be combined with a single cache layer or a single buffer layer may be combined with two cache layers, e.g., a primary cache layer and a secondary cache layer, with reassignment between the given number of layers made possible in a manner similar to reassignment between layers 110 and 112, of FIG. 1, and between layers 310 and 312 of FIG. 2. For example, primary and secondary cache and/or buffer layers may be provided to allow prioritization of particular memory units within the buffer or cache memory.

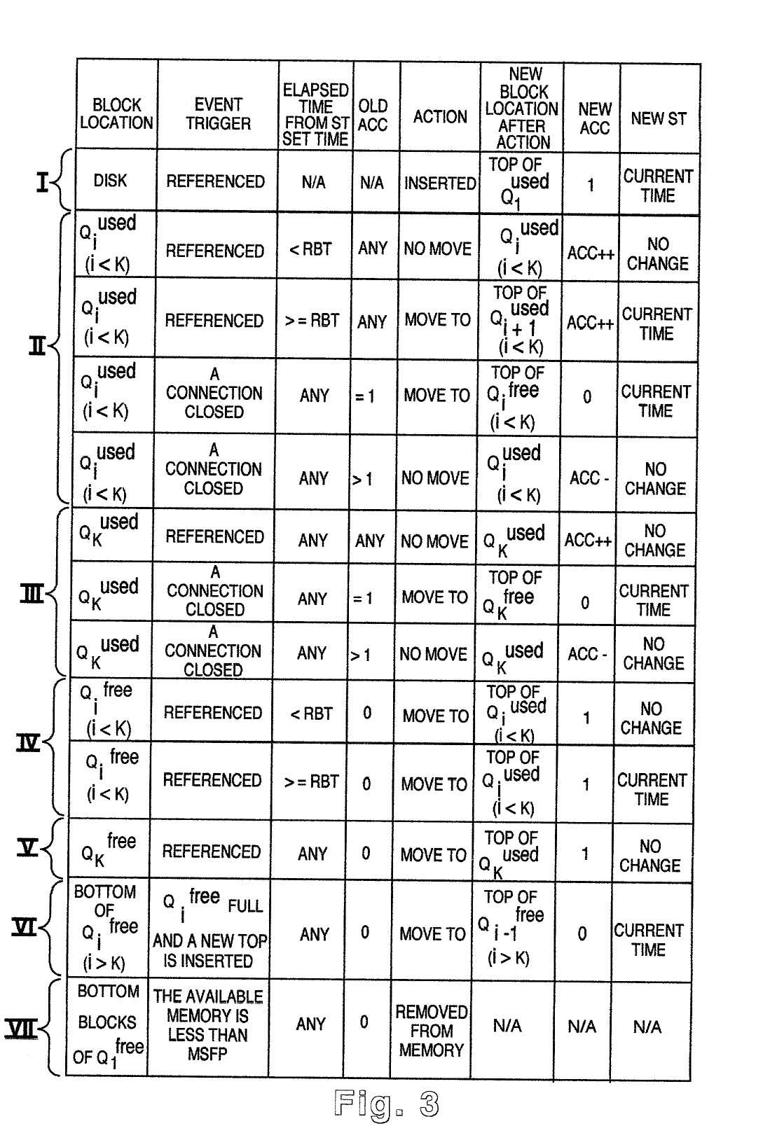

FIG. 3 shows a state transition table corresponding to one embodiment of a logical structure for integrated management of cache memory, buffer memory and free pool memory. One example of such a structure is illustrated in FIG. 2 and described in relation thereto. The table of FIG. 3 includes states operable to be used with an algorithm for managing memory according to such a logical structure.

The table headings of FIG. 3 include BLOCK LOCATION, which corresponds to current or starting assignment of a particular memory block, be it in external storage, buffer layer queue (Qᵢ ^{used}) or cache layer queue (Qᵢ ^{free}), with “i” representing the current queue number and “K” representing the upper-most queue number of the given layer. As previously described in regard to FIG. 2, the lower-most cache layer queue (Q₁ ^{free}) may be characterized as the free pool.

Also included in FIG. 3 is an EVENT TRIGGER heading that indicates certain events which precipitate an action to be taken by the logical structure. In this regard, “referenced” refers to receipt of a request for access to a memory block, “closed connection” represents closure or cessation of a request for access to a memory block. ELAPSED TIME FROM ST SET TIME refers to the time elapsed between the ST and the triggering event, and OLD ACC refers to the ACC value prior to the triggering event. ACTION refers to the action taken by the logical management structure with regard to assignment of a particular memory block upon the triggering event (e.g., based on parameters such as triggering event, current ST value, current ACC value and current memory assignment). NEW BLOCK LOCATION AFTER ACTION indicates the new assignment of a memory block following the triggering event and action taken. NEW ACC refers to how the ACC count is changed following the triggering event and action taken,, i.e., “1” and “0” represent newly assigned ACC integer values, “ACC++” represents incrementation of the current ACC value by one, and “ACC-” represents decrementation of the current ACC value by one. NEW ST indicates whether the ST is reset with the current time or is left unchanged following the given triggering event and action.

FIG. 3 shows seven possible current or starting states for a memory block, for example, as may exist in a system employing the memory management logical structure embodiment of FIG. 2. State I represents a memory block that resides in external storage (e.g., disk), but not in the buffer/cache memory. States II through VII represent memory blocks that reside in the buffer/cache memory, but have different memory queue assignment status. In this regard State II represents a memory block assigned to any buffer layer queue (Qᵢ^{used}) with the exception of the uppermost buffer queue (Q_{K}^{used}). State III represents a memory block assigned to the uppermost buffer queue (Q_{K}^{used}). State IV represents a memory block assigned to any cache layer queue (Qᵢ^{free}) with the exception of the uppermost cache queue (Q_{K}^{free}). State V represents a memory block assigned to the uppermost cache queue (Q_{K}^{free}). State VI represents a memory block assigned to the bottom (e.g., least-recently-used block) of any cache layer queue (Qᵢ^{free}) with the exception of the lowermost cache layer queue or free pool (Qᵢ^{free}). State VII represents a memory block assigned to the bottom (e.g., least-recently-used block) of the lowermost cache layer queue or free pool (Qᵢ^{free}).

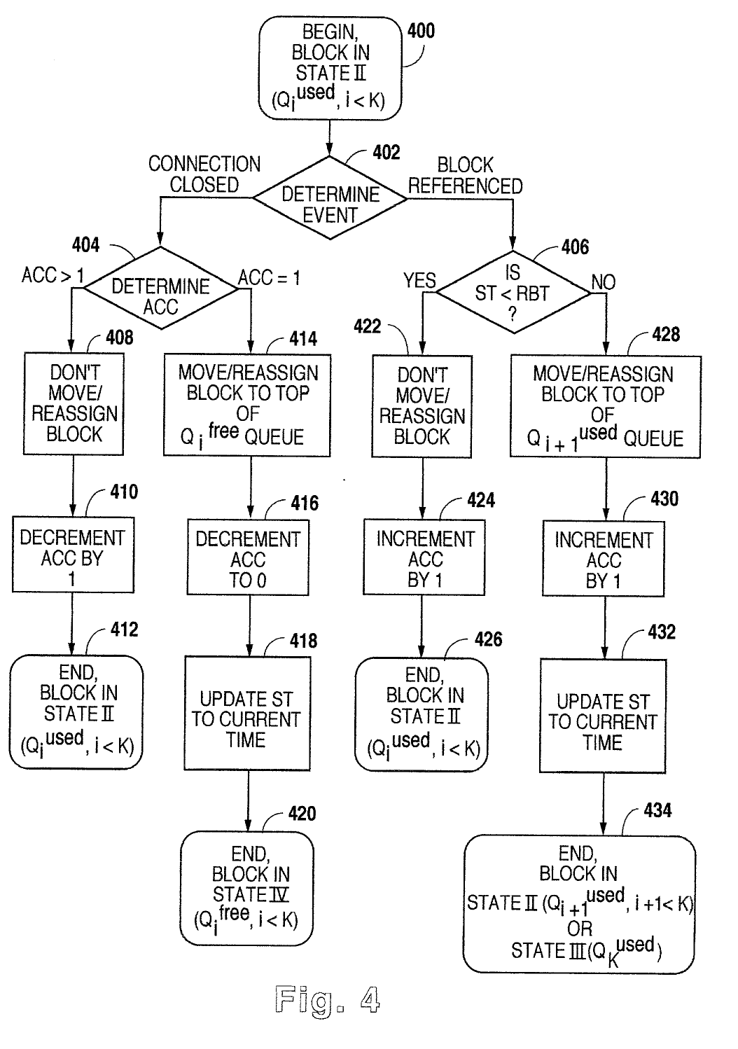

Referring now to the operation of the logical management structure embodiment of FIG. 3, when a memory block is referenced by a request for access, the management structure first determines if the block is available within the buffer/cache memory (i.e., any of STATES II through VII) or is available only from external storage (i.e., STATE I). When a STATE I block is referenced by a request for access, it is inserted into the buffer/cache memory and assigned a new block location at the top of the first buffer layer queue (Q₁^{used}), its ACC value is set to one, and its ST is set to the time of insertion into the queue. A block so inserted into the buffer queue is now in STATE II. FIG. 4 is a flow chart illustrating possible disposition of a STATE II block upon occurrence of certain events and which considers the ACC value of the block at the time of the triggering event.

As illustrated in FIG. 4, a block starting in STATE II begins at 400 in one of the non-uppermost buffer layer queues (Qᵢ^{used},i<K). Upon occurrence of an event, the type of event is determined at 402, either a block reference (e.g., request for access), or a connection closure (e.g., request for access fulfilled). If the event is a connection closure, the current ACC value is determined at 404. If the ACC value is greater than one, the block is not reassigned at 408 and the ACC value is decremented by one at 410, leaving the block at 412 with the same ST and in the same STATE II queue as before the event. If the ACC value is equal to one, the block is reassigned at 414 from the buffer layer queue (Qᵢ^{used}, i<K) to the corresponding cache layer queue (Qᵢ^{free}, i<K), the ACC value is decremented to zero at 416 and the ST is reset to the current time at 418. This leaves the memory block at 420 in a STATE IV queue (Qᵢ^{free}, i<K).

Still referring to FIG. 4, if the event is determined at 402 to be a block reference, the ST is first compared to the RBT at 406. If ST is less than the RBT, the block is not reassigned at 422 and the ACC is incremented by one 424. This leaves the memory block at 426 with the same ST and in the same STATE II queue as before the event. If ST is determined to be greater than or equal to RBT at 406, then the block is reassigned to the top of the next higher buffer layer queue (Qᵢ₊₁ ^{used}) at 428, the ACC is incremented by one at 430 and the ST is reset to the current time at 432. This leaves the memory block at 434 in either the next higher buffer layer queue which is either a STATE II queue (Qᵢ₊₁^{used}), or the uppermost STATE III queue (Q_{K}^{used}) depending on the identity of the starting queue for the memory block.

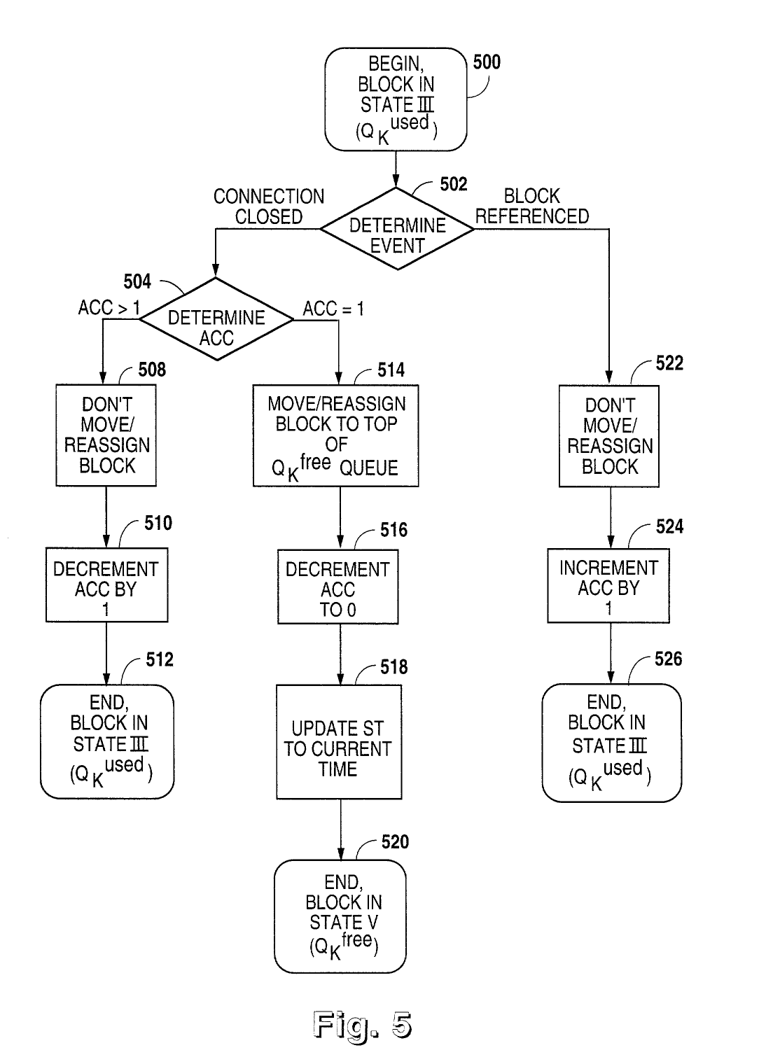

As illustrated in FIG. 5, a block starting in STATE III begins at 500 in the uppermost buffer layer queue (Q_{K}^{used}). Upon occurrence of an event, the type of event is determined at 502, either a block reference or a connection closure. If the event is a connection closure, the current ACC value is determined at 504. If the ACC value is greater than one, the block is not reassigned at 508 and the ACC value is decremented by one at 510, leaving the block at 512 with the same ST and in the same STATE III uppermost buffer layer queue as before the event. If the ACC value is equal to one, the block is reassigned at 514 from the uppermost buffer layer queue (Q_{K}^{used}) to the corresponding uppermost cache layer queue (Q_{K}^{free}), the ACC value is decremented to zero at 516 and the ST is reset to the current time at 518. This leaves the memory block at 520 in the STATE V uppermost cache layer queue (Q_{K}^{free}).

Still referring to FIG. 5, if the event is determined at 502 to be a request for access, the block is not reassigned at 522, and the ACC is incremented by one at 524. This leaves the memory block at 526 with the same ST and in the same STATE III uppermost buffer layer queue as before the event.

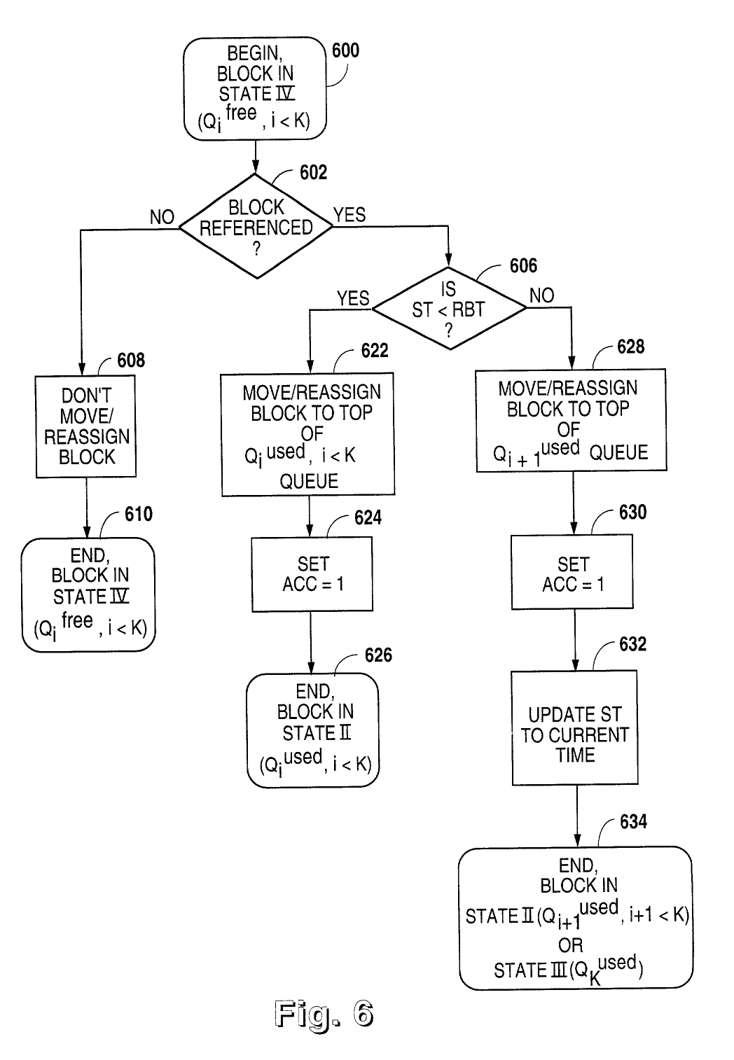

As illustrated in FIG. 6, a block starting in STATE IV begins at 600 in a non-uppermost cache layer queue (Qᵢ^{free}, i<K). Upon occurrence of an event that is determined to be a block reference, the ST is first compared to the RBT at 606. If ST is less than the RBT, the block is reassigned at 622 to the top of the non-uppermost buffer layer queue (Qᵢ^{used}, i<K) corresponding to the starting cache layer queue (Qᵢ^{free}, i<K) and the ACC is set to one at 624. This leaves the memory block at 626 with the same ST as before the event, but now in a STATE II queue (Qᵢ ^{used}, i<K). If ST is determined to be greater than or equal to RBT at 406, then the block is reassigned to the top of the next higher buffer layer queue (Qᵢ^{used}, i<K) at 628, the ACC is set to one at 630 and the ST is reset to the current time at 632. This leaves the memory block at 634 in either in a STATE II queue (Qᵢ₊₁ ^{used}, i+1<K), or in the uppermost STATE III queue (Q_{K}^{used} ) depending on the identity of the starting queue for the memory block.

If no event occurs at 602, then the memory block is not reassigned at 608 and is left at 610 in the same STATE IV queue (Qᵢ^{free}, i<K) as it started. Unless the subject of a block reference, it will be naturally displaced downward in this STATE IV queue (i.e., LRU queue) as new blocks are reassigned to the top of the queue. Disposition of non-referenced memory blocks in the bottom of cache layer queues is described below.

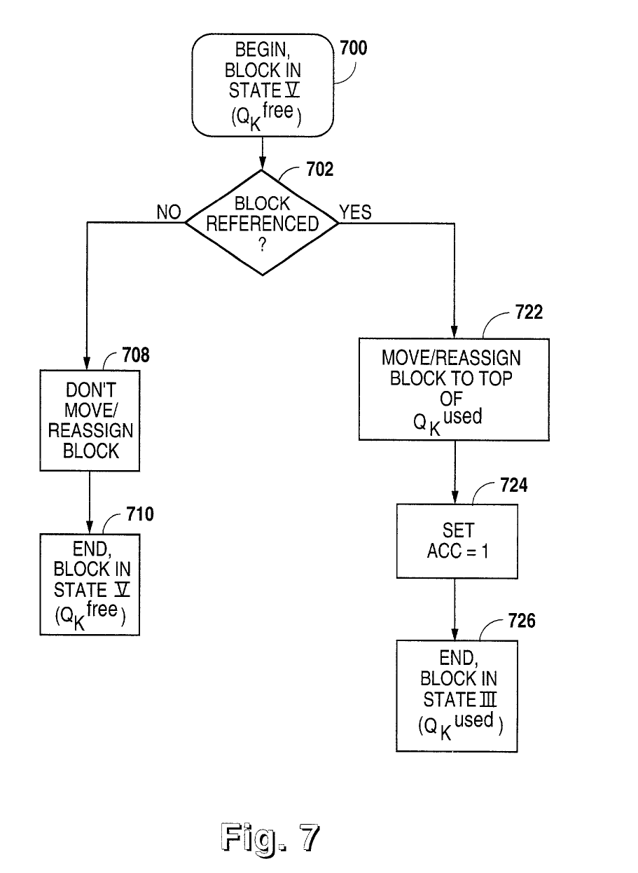

As illustrated in FIG. 7, a block starting in STATE V begins at 700 in the uppermost cache layer queue (Q_{K}^{free}). Upon occurrence of an event that is determined to be a block reference, the block is reassigned at 722 to the top of the uppermost buffer layer queue (Q_{K}^{used}), corresponding to the starting cache layer queue (Q_{K}^{free}) and the ACC is set to one at 724. This leaves the memory block at 726 with the same ST as before the event, but now in the STATE III queue (Q_{K}^{used}). If no event occurs at 702, then the memory block is not reassigned at 708 and is left at 710 in the same STATE V queue (Q_{K}^{free}) as it started. Unless the subject of a block reference, it will be naturally displaced downward in this STATE V queue (i.e., LRU queue) as new blocks are reassigned to the top of the queue. Disposition of a non-referenced memory blocks in the bottom of cache layer queues is described below.

Returning now to FIG. 3, disposition of non-referenced memory blocks in the bottom of cache layer queues will be discussed. These blocks may be described as being in STATE VI (bottom of Qᵢ^{free}, i>1), and in STATE VII (bottom of Q₁^{free}). As previously described STATE VI cache layer queues (Qᵢ^{free}, i>1) may be organized as LRU queues and fixed in sized so that addition of each new block to a given queue results in displacement of a memory block downward to the bottom of the queue, filling the fixed memory space allocated to the queue. As shown in FIG. 3, when a memory block in STATE VI is at the bottom of a fall queue (Qᵢ^{free} i>1) and the triggering event is assignment of a new block to the top of the same queue, the memory block is reassigned from the bottom of (Qᵢ^{free}, i>1) to the top of the next lower cache queue (Qᵢ₋₁^{free}, i>1). Such a reassigned memory block may be described as being in STATE IV Qᵢ^{free}, I<K).

As previously described, the STATE VII cache layer queue (i.e., the free pool Q₁^{free}) may be organized as an LRU queue and configured to be flexible in size so that so that addition of each new block to the free pool queue results in displacement of a memory block downward toward the bottom of the flexible-sized queue. Because the free pool queue (Qᵢ^{free}) is flexible in size it will allow the block to be displaced downward until the point that the available buffer/cache memory is less than the desired minimum size of the free pool memory (“MSFP”). The size of the free pool queue (Qᵢ^{free}) may be tracked, for example, by a block/buffer manager. At this point, the free pool queue (Q₁^{free}) is not allowed to shrink any further so that a minimum amount of free pool memory may be preserved, e.g., for the assignment of newly referenced blocks to the buffer layer caches. When the size of the free pool (Q₁^{free}) shrinks to below the minimum level (MSFP), one or more blocks may be reassigned from the bottom of cache queue (Q₂^{free}) to the top of free pool queue (Q₁^{free}) so that the size of the free pool (Q₁^{free}) is kept greater than or equal to the desired MSFP. When a new block or blocks is assigned to a buffer layer queue from external storage (e.g., a request for access to a new block/s), then one or more blocks may be removed from the bottom of the free pool queue (Q₁^{free}) for use as buffer queue space for the new blocks. It will be understood that such use of a MSFP value is optional.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus and methods may be utilized in various combinations and/or independently. Thus the invention is not limited to only those combinations shown herein, but rather may include other combinations.

What is claimed is:

1. A method of managing memory units using an integrated memory management structure, comprising:
assigning memory units to one or more positions within a buffer memory defined by said integrated structure;
subsequently reassigning said memory units from said buffer memory to one or more positions within a cache memory defined by said integrated structure; and
subsequently removing said memory units from assignment to a position within said cache memory;
wherein said assignment, reassignment and removal of said memory units is based on one or more memory state parameters associated with said memory units.

2. The method of claim 1, wherein said cache memory comprises a free pool memory, and wherein said subsequently removing comprises subsequently removing said memory units from assignment to a position within said free pool memory.

3. The method of claim 2, wherein said assignment and reassignment of said memory units is managed and tracked by a processor or group of processors in an integrated manner.

4. The method of claim 2, wherein said assignment and reassignment of said memory units is managed using identifier manipulation.

5. The method of claim 2, further comprising making one or more of the following reassignments of said memory units within said structure prior to removal of said memory units from said free pool:
reassigning said memory units between multiple positions within said buffer memory; or
reassigning said memory units from said cache memory or from said free pool memory to one or more positions within said buffer memory; or
reassigning said memory units between multiple positions within said cache memory; or
reassigning said memory units between said cache memory and said free pool memory; and
wherein said reassignments of said memory units is based on said one or more memory state parameters.

6. The method of claim 5, wherein said one or more memory state parameters comprise at least one of recency, frequency, popularity, aging time, sitting time (ST), memory unit size, operator assigned keys, or a combination thereof.

7. The method of claim 5, wherein assignment to said buffer memory and reassignment to positions within said buffer memory is made based on changes in an active connection count (ACC) that is greater than zero; and wherein said reassignment to positions within said cache memory or said free pool memory is made based on decrement of an active connection count (ACC) to zero.

8. The method of claim 5, wherein memory units having an active connection count (ACC) greater than zero are maintained within said buffer memory; and wherein memory units having an active connection count (ACC) equal to zero are maintained within said cache memory or free pool memory, or are removed from said free pool memory.

9. The method of claim 8, wherein said active connection count (ACC) associated with each memory unit is tracked by said processor or group of processors; and wherein said processor or group of processors manages said assignment and reassignment of said memory units in an integrated manner based at least partially thereon.

10. The method of claim 5, wherein said buffer memory comprises two or more sequentially ascending buffer memory queues, wherein said free pool memory comprises at least one free pool memory queue corresponding to the lowermost of said sequentially ascending buffer queues, and wherein said cache memory comprises at least one cache memory queue corresponding to another of said buffer memory queues; and wherein said method further comprises:
assigning and reassigning memory units between the queues of said buffer memory based on the relative frequency of requests for access to a given memory unit;
reassigning memory units between said buffer memory and said cache or free pool memories based on relative recency of requests for access to a given memory unit;
assigning and reassigning memory units between the queues of said cache memory and said free pool memory based on the relative frequency of requests for access to a given memory unit; and
removing assignment of said memory units from said free pool memory based on relative recency of requests for access to a given memory unit and need for additional memory for use by said buffer memory.

11. The method of claim 10, wherein said reassignment of said memory units from said buffer memory to said cache memory or free pool memory occurs from a buffer memory queue to a corresponding cache memory queue or free pool memory queue; wherein said reassignment of said memory units from said cache memory or said free pool memory to said buffer memory occurs from a cache memory queue or free pool memory queue to a corresponding or higher sequentially ascending buffer memory queue.

12. The method of claim 11, wherein said reassignment of said memory units between said buffer memory queues occurs from a lower buffer memory queue to a higher sequentially ascending buffer memory queue; wherein reassignment of said memory units between said cache memory queues occurs from a higher sequentially ascending cache memory queue to a lower cache memory queue or free pool memory queue.

13. The method of claim 12, wherein each said buffer memory queue, cache memory queue and free pool memory queue comprises an LRU queue; wherein each said cache memory queue has a fixed size; and wherein a reassignment of said memory units from the bottom of a higher sequentially ascending cache LRU memory queue to a lower cache LRU memory queue or free pool LRU memory queue occurs due to assignment of other memory units to the top of said higher sequential ascending cache LRU memory queue.

14. The method of claim 13, wherein each said buffer memory queue and said free pool memory queue are flexible in size; wherein said buffer memory queues and said free pool memory queue share the balance of the memory not used by said fixed size cache memory queues; and wherein a removal of said memory units occurs from the bottom of said free pool LRU memory queue to transfer free memory space to one or more of said buffer memory queues to provide sufficient space for assignment of new memory units to one or more of said buffer memory queues.

15. A method of managing memory units using a multi-dimensional logical memory management structure, comprising:
providing two or more spatially-offset organizational sub-structures, said substructures being spatially offset in symmetric or asymmetric spatial relationship to form said multi-dimensional management structure, each of said sub-structures having one or more memory unit positions defined therein; and
assigning and reassigning memory units between memory unit positions located in different organizational sub-structures, between positions located within the same organizational sub-structure, or a combination thereof;
wherein said assigning and reassigning of memory units within said structure is based on multiple memory state parameters.

16. The method of claim 15, wherein said spatially offset organization structures comprise two or more spatially-offset rows, columns, layers, queues, or any combination thereof.

17. The method of claim 15, wherein one or more of said spatially-offset organizational substructures are subdivided into two or more positions within the substructure, said positions being organized within the substructure in a sequentially ascending or descending manner.

18. The method of claim 15, wherein said assignments and reassignments of a memory unit within said multi-dimensional structure results in mapping a relative positioning of said memory unit that reflects an updated cache value of said memory unit relative to other memory units in said structure in terms of said multiple memory state parameters.

19. A method of managing memory units using an integrated two-dimensional logical memory management structure, comprising:
providing a first horizontal buffer memory layer comprising two or more sequentially ascending buffer memory positions;
providing a first horizontal cache memory layer comprising two or more sequentially ascending cache memory positions, said first horizontal cache memory layer being vertically offset from said first horizontal buffer memory layer;
horizontally assigning and reassigning memory units between said buffer memory positions within said first horizontal buffer memory layer based on at least one first memory state parameter;
horizontally assigning and reassigning memory units between said cache memory positions within said first horizontal cache memory layer based on at least one second memory state parameter; and
vertically assigning and reassigning memory units between said first horizontal buffer memory layer and said first horizontal cache memory layer based on at least one third memory state parameter.

20. The method of claim 19, wherein a lowermost memory position of the sequentially ascending cache memory positions of said horizontal cache memory layer comprises a free pool memory position; and further comprising removing said memory units from said free pool memory based on at least said second parameter and a need for additional memory for use by said buffer memory.

21. The method of claim 19, wherein reassignment of a memory unit from a first position to a second position within said structure is based on relative positioning of said first position within said structure and on said first and second parameters; and wherein said relative positioning of said second position within said structure reflects a renewed cache value of said memory units relative to other memory units in the structure in terms of at least two of said first, second and third parameters.

22. The method of claim 19, wherein each of said vertical and horizontal assignments and reassignments of a memory unit within said two-dimensional structure results in mapping a relative positioning of said memory unit that reflects an updated cache value of said memory unit relative to other memory units in said structure in terms of at least two of said first, second and third parameters without requiring individual values of said parameters to be explicitly recorded and recalculated.

23. The method of claim 20, wherein each of said vertical and horizontal assignments and reassignments of a memory unit within said two-dimensional structure results in mapping a relative positioning of said memory unit that reflects an updated relative cache value of said memory unit relative to other memory units in said structure in terms of at least two of said first, second and third parameters, and that allows removal of memory units having the least relative cache value in terms of at least two of said first, second and third parameters, without requiring individual values of said parameters to be explicitly recalculated and resorted.

24. The method of claim 20, wherein said first memory state parameter comprises a frequency parameter, wherein said second memory state parameter comprises a recency parameter, and wherein said third parameter comprises a connection status parameter.

25. The method of claim 24, wherein each said buffer memory position comprises a buffer memory queue; wherein each said cache memory position comprises a cache memory queue; and wherein intra-queue positioning occurs within each buffer memory queue based on a fourth memory state parameter; and wherein intra-queue positioning with each cache memory queue and free pool memory queue occurs based on a fifth memory state parameter.

26. The method of claim 25, wherein said fourth and fifth memory state parameters comprise recency parameters.

27. The method of claim 26, wherein said each buffer memory queue, cache memory queue and free pool memory queue comprise LRU memory queues.

28. The method of claim 26, further comprising:
horizontally assigning and reassigning memory units between said buffer memory queues within said first horizontal buffer memory layer based on the relative frequency of requests for access to a given memory unit;
vertically reassigning memory units between said buffer memory queues and said cache or free pool memory queues based on status of active requests for access to a given memory unit;
horizontally assigning and reassigning memory units between said cache memory queues and said free pool memory queues based on the relative recency of requests for access to a given memory unit; and
removing said memory units from said free pool memory queue based on relative recency of requests for access to a given memory unit and need for additional memory for use by said buffer memory.

29. The method of claim 28, wherein said first parameter comprises a relative value of an active connection count (ACC) greater than zero that is associated with said memory units; and wherein said third memory state parameter comprises absence or presence of an active connection associated with said memory units.

30. The method of claim 20, wherein said assignments and reassignments are managed and tracked by a processor or group of processors in an integrated manner.

31. The method of claim 20, wherein said assignment and reassignment of said memory units is managed using identifier manipulation.

32. The method of claim 20, further comprising:
providing a second horizontal buffer memory layer comprising two or more sequentially ascending buffer memory positions, said second horizontal buffer memory layer being vertically offset from said first horizontal buffer memory layer; or
providing a second horizontal cache memory layer comprising two or more sequentially ascending buffer memory positions, said second horizontal buffer memory layer being vertically offset from said first horizontal cache memory layer;
horizontally assigning and reassigning memory units between said memory positions within said second horizontal buffer memory layer or said second horizontal cache memory layer based on at least one sixth memory state parameter; and
vertically assigning and reassigning memory units between said second horizontal buffer memory layer or said second horizontal cache memory layer and said first horizontal buffer memory layer or said first horizontal cache memory layer based on at least one seventh memory state parameter.

33. An integrated two-dimensional logical memory management structure, comprising:
at least one horizontal buffer memory layer comprising two or more sequentially ascending buffer memory positions; and
at least one horizontal cache memory layer comprising one or more sequentially ascending cache memory positions and a lowermost memory position that comprises a free pool memory position, said first horizontal cache memory layer being vertically offset from said first horizontal buffer memory layer.

34. The memory management structure of claim 33, wherein said each of said sequentially ascending cache memory positions and said free pool memory position uniquely correlates to one of said sequentially ascending buffer memory positions.

35. The memory management structure of claim 33, wherein memory units are operably assignable, reassignable and trackable between each of said buffer memory positions, cache memory positions and said free pool memory position by a processor or group of processors in an integrated manner.

36. The memory management structure of claim 35, wherein memory units are operably placeable within each of said buffer memory positions, cache memory positions or said free pool memory position using identifier manipulation.

37. A method of managing memory units, comprising:
assigning a memory unit to one of two or more memory positions based on a status of at least one memory state parameter;
wherein said two or more memory positions comprise at least two positions within a buffer memory; and
wherein said at least one memory state parameter comprises an active connection count (ACC).

38. The method of claim 37, wherein said two or more memory positions further comprise at least two positions within a cache memory, each of said two positions in said cache memory corresponding to a respective one of said two positions within said buffer memory.

39. The method of claim 37, wherein said assigning comprises assigning said memory unit to a first memory position based on a first status of said at least one memory state parameter; and reassigning said memory unit to a second memory position based on a second status of said at least one memory state parameter, said first status of said memory state parameter being different than said second status of said memory state parameter.

40. The method of claim 37, wherein said first memory position comprises a position within a first memory queue, and wherein said second memory position comprises a position within a second memory queue.

41. The method of claim 37 wherein said first memory position comprises a first position within said buffer memory, and wherein said second memory position comprises a second position within said buffer memory.

42. The method of claim 37 wherein said first memory position comprises a position within a first buffer memory queue, and wherein said second memory position comprises a position within a second buffer memory queue.

43. The method of claim 37, wherein said first memory position comprises a position within a buffer memory, and wherein said second memory position comprises a position within a cache memory or a free pool memory.

44. The method of claim 37, wherein said first memory position comprises a position within a buffer memory queue, and wherein said second memory position comprises a position within a cache memory queue or a free pool memory queue.

45. The method of claim 38, wherein said status of said memory state parameter comprises an active connection count (ACC) number associated with said memory unit; and wherein said buffer memory comprises a plurality of positions, each buffer memory position having a sequential identification value associated with said buffer memory position, and wherein said cache memory comprises a plurality of positions, each cache memory position having a sequential identification value associated with said cache memory position that correlates to a sequential identification value of a corresponding buffer memory position, each of said sequential identification values corresponding to a possible active connection count (ACC) number or range of possible active connection count (ACC) numbers that may be associated with a memory unit at a given time; and
wherein if said active connection count (ACC) number is greater than zero, said assigning comprises assigning said memory unit to a first buffer memory position that has a sequential identification value corresponding to the active connection count (ACC) number associated with said memory unit; and wherein said method further comprises leaving said memory unit in said first buffer memory position until a subsequent change in the active connection count (ACC) number associated with said memory unit, and reassigning said memory unit as follows upon a subsequent change in the active connection count (ACC) number associated with said memory unit:
if said active connection count (ACC) number increases to a number corresponding to a sequential identification value of a second buffer memory position, then reassigning said memory unit from said first buffer memory position to said second buffer memory position;
if said active connection count (ACC) number increases to a number corresponding to the same sequential identification value of said first buffer memory position, or decreases to a number that is greater than or equal to one, then leaving said memory unit in said first buffer memory position; or
if said number of active connection count (ACC) number decreases to zero, then reassigning said memory unit from said first buffer memory position to a first cache memory position that has a sequential identification number that correlates to the sequential identification number of said first buffer memory position.

46. The method of claim 45, further comprising reassigning said memory unit from said first cache memory position in a manner as follows:
if said active connection count (ACC) number increases from zero to a number greater than zero, then reassigning said memory unit from said first cache memory position to a buffer memory position that has one higher sequential identification value than the sequential identification value associated with said first cache memory position, or to a buffer memory position that has the highest sequential identification number if said first cache memory position is associated with the highest sequential identification number; or
if said number of current active connections remains equal to zero, then subsequently reassigning said memory unit to a cache memory position having one lower sequential identification value than the sequential identification value associated with said first cache memory position, or removing said memory unit from said cache memory if said first cache memory position is associated with the lowermost sequential identification number.

47. The method of claim 41, further comprising determining a sitting time (ST) value associated with the time that said memory unit has resided within said first buffer memory position and comparing said sitting time (ST) value with a resistance barrier time (RBT) value prior to reassigning said memory unit from said first buffer memory position to said second buffer memory position; and leaving said memory unit within said first buffer memory position based on said comparison of said sitting time (ST) value with said resistance barrier time (RBT) value.

48. The method of claim 43, further comprising determining a file size value associated with said memory unit and comparing said file size value with a file size threshold value prior to reassigning said memory unit from said buffer memory position to a cache memory position; and assigning said memory unit to said free pool memory position rather than a cache memory position based on said comparison of said file size value and said file threshold value.

49. The method of claim 45, wherein each buffer memory position and each cache memory position comprises an LRU queue.

50. The method of claim 46, wherein each buffer memory position comprises an LRU buffer queue having a flexible size; and wherein the cache memory position having the lowermost sequential identification value comprises an LRU free pool queue having a flexible size; wherein each cache memory position having a sequential identification value greater than the lowermost sequential identification number comprises an LRU cache queue having a fixed size, with the total memory size represented by said LRU buffer queues, said LRU cache queues and said LRU free pool being equal to a total memory size of a buffer/cache memory; and
wherein said reassignment of said memory unit from said first cache memory position to a cache memory position having one lower sequential identification value occurs due to LRU queue displacement to the bottom and out of said respective fixed size LRU cache queue; and
wherein said removal of said memory unit from said cache memory position having the lowermost sequential identification number occurs due to LRU queue displacement of said memory unit to the bottom of said LRU free pool queue and subsequent reuse of buffer/cache memory associated with said memory unit at the bottom of said flexible LRU free pool queue for a new memory unit assigned from external storage to a buffer memory position.

51. The method of claim 37, wherein said assignment and reassignment of said memory units is managed and tracked by a processor or group of processors in an integrated manner.

52. The method of claim 37, wherein said assignment and reassignment of said memory units is managed using identifier manipulation.

53. The method of claim 37, wherein said method further comprises assigning said memory unit to said one of two or more memory positions based at least partially on the status of a flag associated with said memory unit.

54. The method of claim 53, wherein said flag represents a priority class associated with said memory unit.

55. The method of claim 37, wherein said memory units comprise memory blocks.

56. A method for managing content in a network environment comprising:
determining the number of active connections associated with content used within the network environment; and
referencing the content location based on the determined connections.

57. The method of claim 56, further comprising:
obtaining the content from an external storage device operably coupled to the network environment;
referencing the content into an available used memory reference;
incrementing a count parameter associated with the content upon determining an active connection status; and
updating a time parameter associated with the content upon referencing the content.

58. The method of claim 56, further comprising:
locating the content in a free memory reference;
referencing the content using an available used memory reference in response to determining the active connection status; and
incrementing a count parameter associated with the content upon determining the active connection status.

59. The method of claim 58 further comprising updating a time parameter associated with the content upon referencing the content.

60. The method of claim 56, further comprising:
receiving a request for the content; and
updating a count parameter in response to the request.

61. The method of claim 56, further comprising updating a time parameter associated with the content upon referencing the content.

62. The method of claim 61, further comprising determining a resistance barrier timer parameter value operable to reduce re-referencing of the content.

63. The method of claim 62, further comprising:
comparing the resistance barrier timer parameter to the time parameter;
determining a second reference; and
performing an action in response to comparing the resistance timer parameter value to the time parameter value.

64. The method of claim 63, further comprising maintaining the reference to the content upon determining a timer parameter value that is less than the resistance barrier timer value.

65. The method of claim 56, further comprising:
detecting an active connection for referencing the content;
determining the reference of the content;
comparing a timer value to a resistance timer barrier value; and
processing the content in response to the comparison.

66. The method of claim 65, further comprising:
maintaining the reference if the timer value is less than the resistance timer barrier value; and
incrementing a counter in response to detecting an active connection.

67. The method of claim 65, further comprising:
re-referencing the content to a second reference;
incrementing a counter associated with the content; and
updating the time parameter associated with the content.

68. The method of claim 65, further comprising:
maintaining the content using the reference upon determining the reference is associated with a used cache memory; and
incrementing a counter associated with the content.

69. The method of claim 65, further comprising:
re-referencing the content to a used memory upon detecting a time parameter value less than a resistance time barrier value;
setting a counter to a value of one; and
updating the time parameter upon re-referencing the content.

70. The method of claim 65, further comprising;
re-referencing the content to a used memory of a second used memory upon determining a time parameter value greater than or equal to the resistance barrier time value;
setting a counter to a value of one; and
updating the time parameter upon re-referencing the content.

71. The method as recited in claim 56, further comprising:
detecting a closed connection associated with accessing the content;
determining the reference associated with the content; and
decrementing a count value associated with the content in response to the closed connection.

72. The method of claim 71, further comprising:
determining the count value associated with the content;
re-referencing the content in response to determining count value equal to zero; and
updating a time parameter upon re-referencing the content.

73. A network processing system operable to process information communicated via a network environment comprising:
a network processor operable to process network communicated information; and
a memory management system operable to reference the information based upon a connection status associated with the information.

74. The system of claim 73, wherein the memory management system comprises:
a first used memory reference operable to reference the information in response to determining
an active connection status; and
a second free memory reference operably associated with the first used memory reference and operable to provide a reference to the content in response to determining the active connection status.

75. The system of claim 74, further comprising:
a used memory reference coupled to the first used memory reference and the first free memory reference; and
a second free memory reference coupled to the second used memory reference and the first free memory reference.

76. The system of claim 75, further comprising the second used memory reference operable to reference content referenced by the first used memory reference and the first free memory reference based upon a parameter associated with the content.

77. The system of claim 75, further comprising the second free memory reference operable to reference content referenced by the second used memory reference based on a connection status associated with the content.

78. The system of claim 75, further comprising the second free memory reference operable to provide a reference to the content to the first free memory reference based upon a parameter association with the content.

79. The system of claim 73, further comprising the memory operable to reference content based on a time parameter associated with the information.

80. The system of claim 73, further comprising the memory operable to reference content based on a resistance time barrier value associated with one or more memory references.

81. A method for managing content within a network environment comprising:
determining the number of active connections associated with content used within the network environment;
referencing the content based on the determined connections;
locating the content in a memory;
referencing the content using an available free memory reference;
incrementing an active count parameter associated with the content upon detecting the new connection.
